(19) United States
(12) Patent Application Publication
(10) Pub. No.: US 2022/0118476 A1
(43) Pub. Date: Apr. 21, 2022

(54) IMPROVED METHOD FOR APPLYING SILANE-BASED COATINGS ON SOLID SURFACES, IN PARTICULAR ON METAL SURFACES

(71) Applicant: CHEMETALL GMBH, Frankfurt (DE)

(72) Inventors: Ilya Ostrovsky, Frankfurt am Main (DE); Veronika Braehler, Geisa (DE)

(21) Appl. No.: 17/428,679

(22) PCT Filed: Feb. 7, 2020
(86) PCT No.: PCT/EP2020/053084

§ 371 Date: Aug. 5, 2021

(30) Foreign Application Priority Data
Feb. 13, 2019 (EP) 19156878.1

(51) Int. Cl. B05D 1/18; C09D 5/08; B05D 3/02; B05D 3/04; B05D 7/14; C09D 183/04; B05D 3/00

(52) U.S. Cl. CPC B05D 1/18; C09D 5/08; B05D 3/0254; B05D 3/002; B05D 7/14; C09D 183/04; B05D 3/0406

(57) ABSTRACT

Described herein is an improved method for applying silane-based coatings to solid surfaces, in particular metal surfaces. Also described herein are a silane-containing composition, a solid surface, in particular a metal surface, including a silane-based coating, and a method of using the silane-based coating in the transportation industry or in electrically conductive assembling.

The present invention refers to an improved method for applying silane-based coatings to solid surfaces, in particular metal surfaces, to an according silane-containing composition as well as to a solid surface, in particular a metal surface, with an according silane-based coating and its use in the field of transportation industry or electrically conductive assembling.

Within the field of metal surface treatment, silane-based corrosion-protective coatings are well-known. At that, silanes are normally used to form a very thin layer of only a few nanometers on the metal surface. Such a layer exhibits cross-links with the metal surface on the one hand and the polymeric chains of a paint on the other hand providing good paint adhesion and thereby good corrosion protection. A corresponding prior art method for applying silane-based coatings is for example disclosed in U.S. Pat. No. 7,011,719 B2.

However, said thin layers cannot be used to protect the metal without paint, i.e. to provide blank corrosion resistance to the metal. In order to achieve the latter, it is rather necessary to form a thick silane layer on the metal surface. In general, such a layer should have a thickness of a few micrometers, which is very thick for silane-based coatings. Moreover, said thick layers are advantageous, because they may include corrosion inhibitors and provide not only barrier protection but also active corrosion protection and self-healing effects helping to improve the protection of painted metals as well.

In order to allow the formation of cross-links with the metal surface, the silanes are pre-hydrolyzed by mixing them with water to an according treatment solution first. At that, the —C—O—Si— groups are partially hydrolyzed to —C—OH and HO—Si— (silanol) groups. When subsequently bringing the treatment solution into contact with the metal surface, the silanol groups may condense with metal hydroxide (HO—M-) groups on the metal surface, forming —Si—O—M- groups, i.e. the cross-links. The silanol groups of different silane molecules may also react with each other to siloxane (—Si—O—Si—) groups forming dimers, trimers, oligomers and/or polymers the remaining, i.e. still active silanol groups of which may then condense with metal hydroxide groups on the metal surface forming a thick barrier layer.

The higher the concentration of silanes and hence of silanol groups in the according aqueous treatment solution, the higher the probability of silanol polymerization and thus—theoretically—the higher the thickness of the obtained layer. However, too concentrated silane solutions are not stable due to condensation and sedimentation. Hence, the formation of thick silane-based coatings on metal surfaces is still rather unsatisfactory.

Furthermore, every time a silane or mixture of silanes is pre-hydrolyzed before being applied on the metal surface, a certain amount of organic solvents is needed to stabilize the resulting silane solution, i.e. to prevent the solution from sedimentation. However organic solvents, i.e. so-called VOCs (volatile organic compounds), should nowadays be avoided due to toxicological and environmental concerns.

Some silanes that exhibit good anti-corrosion properties, for example polysulfane silanes that provide high corrosion resistance to magnesium, aluminum, copper and other metals, are not stable in water-based solutions at all. They may only be stable in organic-solvent-based solutions.

It was therefore the object of the present invention to provide an improved method for applying silane-based coatings on metal surfaces which allows to effectively apply thick silane-based coatings on the one hand and to reduce the required amount of organic solvents, in particular when using silanes not being stable in water-based solutions, on the other hand.

The main difference between the present invention and the prior art is the application of unhydrolyzed silane/s on the metal surface with the subsequent hydrolysis of the applied silane layer (“in place”).

According to the present invention, in the improved method for applying silane-based coatings to solid surfaces a solid surface, in particular an optionally anodized or conversion-coated metal surface, is:
i) optionally cleaned, etched and/or desmutted,
ii) brought into contact with at least one unhydrolyzed silane such that an unhydrolyzed silane layer is formed on the solid surface,
iii) brought into contact with water such that the silane layer is at least partially hydrolyzed,
iv) at least partially dried such that residues of water and alkanol are at least partially removed from the solid surface,
v) optionally heated such that the at least partially hydrolyzed and least partially dried silane layer is cured, and
vi) in case that step v) is conducted, optionally painted.

### Definitions

The steps i) to vi) of the method according to the present invention are conducted in the order according to their numbering. In some cases, it might be advantageous to conduct one or more additional steps, for example rinsing steps. Thus, the conduction of steps other than steps i) to vi) should not be excluded. However, it is preferred that between steps ii) and iii), between steps iii) and iv) as well as between steps iv) and v) no additional step is conducted.

In the present invention, a “solid surface” is defined as a surface on which a silane-based coating may be applied with the prior art method using pre-hydrolyzed silanes, i.e. which exhibit groups capable of reacting with silanol groups.

In the present invention, a “metal surface” is defined as a solid surface containing or even consisting of, preferably consisting of at least one metal.

Herein, an “aluminum alloy” is to be understood as an alloy containing more than 50 mol-% of aluminum whereas a “magnesium alloy” is to be understood as an alloy containing more than 50 mol-% of magnesium.

In the present invention, a “silane” is defined as an organosilane—i.e. a silane exhibiting organic moieties—that has at least one non-hydrolysable moiety which is linked to Si via a C—Si bond as well as at least two hydrolysable moieties which are linked to Si via a C—O—Si group per molecule. A silane may contain one, two or even more Si-atoms per molecule.

Herein, an “unhydrolyzed” silane/silane layer is defined in such a way that the silane/silane layer has not intentionally been brought into contact with water (liquid or gaseous) before conducting step iii) of the method according to the present invention, preferably in such a way that at least 90 mol-%, more preferably that at least 93 mol-%, even more preferably that at least 96 mol-% and most preferably that at least 99 mol-% of the hydrolysable C—O—Si bonds are not yet hydrolyzed.

For example, the solid surface to be coated may belong to an air, land or marine vehicle, in particular to an air vehicle like an airplane.

The method of the invention is especially suitable for coating metals, plastics, glasses as well as composite materials and the solid surface to be coated preferably contains or even consist of at least one metal, at least one plastic, at least one glass and/or at least one composite material.

Suitable plastics are for example polyurethanes, polyamides and acrylonitrile butadiene styrenes, whereas suitable glasses are for example optical glasses and sapphire glasses. As composite materials all composites with a metal, plastic or glass matrix are suitable, for example fiber metal laminates like aluminum reinforced by glass fiber, fiber polymer composites and metal matrix composites.

It case of glasses as well as of plastics, the method of the invention is inter alia suitable for adhesive bonding preparation, coating with functionalized particles, for example graphene particles, and building hydrophobic coatings.

The solid surface to be coated preferably contains or even consists of at least one metal—i.e. is a metal surface—, in particular at least one lightweight metal which is optionally anodized. At that, the at least one light weight metal is preferably selected from the group consisting of aluminum, aluminum alloys, magnesium and magnesium alloys, more preferably from the group consisting of aluminum and aluminum alloys. Most preferably, the solid surface to be coated contains or even consists of at least one aluminum alloy.

At that, the at least one aluminum alloy is preferable a high-strength aluminum alloy selected from the AA2XXX or the AA7XXX series, which are important construction metals in the field of transportation industry, especially in the field of aerospace industry. The blank corrosion resistance obtained with the method according to the present invention is equal to the one obtained with chrome-based chemical conversion coatings and has never been achieved with a chrome-free conversion coating—such as a silane-based coating—on an AA2XXX alloy before. An even more preferred aluminum alloy is an AA2024 alloy, for example AA2024-T3.

The method is also suitable for multi-metal applications, i.e. for applying a silane-based coating to a solid surface containing at least two different metals, for example aluminum and magnesium, or to at least two different solid surfaces containing at least one metal without modifying steps i) to vi) of the method.

The at least one metal may already exhibit a conversion coating. The method of the invention is then a post-treatment method for the already conversion-coated at least one metal.

According to a preferred embodiment, step i) of the method is conducted, wherein more preferably the solid surface is cleaned. The surface must be clean and wetable for good adhesion of the at least one unhydrolyzed silane which is applied in step ii) of the method. In case that the solid surface is a metal surface which contains or even consists of aluminum and/or at least one aluminum alloy, it is preferred to first clean the surface, then etch it with an alkaline solution and finally desmut it.

At that, a suitable cleaning solution is Ardrox® 6490, a suitable etching solution is Oakite® 160 and a suitable desmutting solution is Ardrox® 295 GD (all products available from Chemetall GmbH, Germany).

In step ii) of the method, the solid surface is brought into contact with at least one unhydrolyzed silane such that an unhydrolyzed silane layer is formed on the solid surface.

According to a first preferred embodiment, the at least one unhydrolyzed silane has at least non-hydrolysable moiety which exhibits at least one functional group selected from the group consisting of amino, vinyl, ureido, epoxy, mercapto, isocyanato, thiocyanato, methacrylato, vinylbenzene and sulfane, more preferably from the group consisting of amino, mercapto, thiocyanato and polysulfane, most preferably from the group consisting of mercapto and sulfane. Said at least one functional group may react with functional groups within a paint being subsequently applied and thereby help improving paint adhesion.

According to a second preferred embodiment, the at least unhydrolyzed silane has at least two hydrolysable moieties which are independently from one another selected from the group consisting of methoxy, ethoxy and propoxy, more preferably from the group consisting of methoxy and ethoxy.

According to a third preferred embodiment, the at least one unhydrolyzed silane has at least non-hydrolysable moiety which exhibits at least one functional group selected from the group consisting of amino, vinyl, ureido, epoxy, mercapto, isocyanato, thiocyanato, methacrylato, vinylbenzene and sulfane, more preferably from the group consisting of amino, mercapto, thiocyanato and polysulfane, most preferably from the group consisting of mercapto and polysulfane, as well at least two hydrolysable moieties which are independently from one another selected from the group consisting of methoxy, ethoxy and propoxy, more preferably from the group consisting of methoxy and ethoxy.

Suitable silanes include for example bis(triethoxysilylpropyl)tetrasulfane, mercaptopropylmethyldimethoxysilane and thiocyanatopropyltriethoxysilane.

According to an especially preferred embodiment, the at least one unhydrolyzed silane is selected from the group consisting of sulfur-containing silanes, i.e. silanes having at least one S-atom per molecule, more preferably from the group consisting of polysulfane silanes, i.e. silanes having at least one —Sₙ— moiety with n=2 to 18, preferably with n=2 to 5, and mercapto silanes, even more preferably from the group consisting of polysulfane silanes and most preferably from the group consisting of polysulfane silanes being bi-silanes, i.e. having two Si-atoms per molecule. At that, an especially suitable mixture of bi-silanes each having one —Sₙ— moiety, wherein the average n is 4, is Oxsilan® MG-0611 (available from Chemetall GmbH, Germany). Said sulfur-containing silanes are especially advantageous in case of AA2024 alloys, as the sulfur surprisingly has a corrosion-inhibiting effect on these alloys.

According to the invention, the unhydrolyzed silanes may even be silanes which are not stable in water-based solutions at all and may only be stable in organic-solvent-based solutions, e.g. polysulfane silanes. At that, water-based solutions are solutions in which more than 10 wt.-% of the solvents are water, whereas in organic-solvent-based solutions more than 90 wt.-% of the solvents are organic solvents.

According to a first preferred embodiment the at least one unhydrolyzed silane is mixed with at least one other compound not including water and then applied together with said at least one other compound to the solid surface.

Preferably, the at least one unhydrolyzed silane is mixed with at least one corrosion inhibitor and then applied together with the at least one corrosion inhibitor to the solid surface. At that, the at least one corrosion inhibitor is preferably selected from the group consisting of benzotriazole and α-amino acids, such as I-cysteine, I-cystine or I-serine. An especially preferred corrosion inhibitor is benzotriazole (e.g. available as Irgamet® BTZ from BASF SE, Germany).

Optionally, the at least one unhydrolyzed silane is mixed with at least one hydrolysis catalyst, more preferably with at least one hydrolysis catalyst selected from the group consisting of organic and inorganic acids, especially preferably with acetic acid, in particular with glacial acetic acid, and then applied together with the at least one hydrolysis catalyst to the solid surface.

It is also possible, that the at least one unhydrolyzed silane is mixed with at least one corrosion inhibitor as previously described as well as with at least one hydrolysis catalyst as previously described.

It is possible to mix the at least one unhydrolyzed silane with organic solvents, e.g. with glycol ethers like propylene glycol n-butyl ether (Dowanol® PnB, Dow, USA) or propylene glycol methyl ether (Dowanol® PM, Dow, USA) before applying it to solid surface. However, it is also possible and preferred not to mix the at least one unhydrolyzed silane with organic solvents. As already mentioned above, organic solvents, i.e. so-called VOCs (volatile organic compounds), should nowadays be avoided due to toxicological and environmental concerns.

According to an especially preferred embodiment, the at least one unhydrolyzed silane is mixed with at least one water-free and water-unsoluble powder preferably containing or even consisting of graphite, graphene, zirconium oxide, titanium oxide, silicon oxide, silicon carbide and/or aluminum oxide before applying the at least one unhydrolyzed silane to the solid surface.

For example, graphite can be used for conductivity improvement of the surface, whereas graphene offers conductivity as well as mechanical and anticorrosion improvement. Metal oxides like zirconium and titanium oxide offer improvement of mechanical properties.

The addition of at least one water-free, water-unsoluble and electrically conductive powder, preferably containing or even consisting of graphite and/or graphene, can be used to produce electrically conductive silane-based coatings on metal surfaces. This is especially advantageous in the field of electrically conductive assembling, where unpainted metal surfaces are often used as electrical conductors, for example to provide grounding for structures.

The method of the present invention may for example be used to form so-called touch-up coatings for lightning protection on aircraft structures. Usually, such structures are almost fully painted or anodized. Only a small spot is masked during the painting or anodizing. Then, the masking is removed and the spot is treated according to the present invention. After drying, the spot is used to mount electrical conductors and then to connect to the grounding system of the aircraft. The method may inter alia be used to form electrically conductive coatings on radar antennas or board computer housings as well.

According to a second preferred embodiment, the at least one unhydrolyzed silane is applied in pure form, i.e. without the addition of any other substances. However, the at least one unhydrolyzed silane may accidently contain minor amounts of other substances being impurities of the at least one silane and/or originating from the treated metal surface and/or from the surrounding atmosphere.

In step ii) of the method, the solid surface is preferably brought into contact with the at least one unhydrolyzed silane by immersion of the solid surface into the at least one silane or by spraying, rolling or brushing the at least one silane on the solid surface, especially preferably by immersion of the solid surface into the at least one silane.

Step ii) is preferably conducted at a temperature in the range of 10 to 50° C., especially preferably at room temperature, i.e. at a temperature in the range of 15 to 30° C., preferably of 20 to 25° C., whereas, the contact time in step ii) preferably lies in the range of 1 second to 15 minutes, more preferably of 2 to 10 minutes and especially preferably of 4 to 6 minutes.

The thickness of the unhydrolyzed silane layer formed on the solid surface in step ii) depends on the specific silane/s used and its/their viscosity. However, the thickness usually lies within the range of 1 to 5 micrometers.

In step iii) of the method, the solid surface is brought into contact with water, preferably deionized water, such that the silane layer formed in step ii) is at least partially hydrolyzed, i.e. at least partially becomes a silanol layer.

Optionally, the water used in step iii) contains at least one corrosion inhibitor. At that, the at least one corrosion inhibitor is preferably selected from the group consisting of vanadates, molybdates, bismuth and α-amino acids, such as I-cysteine, I-cystine or I-serine.

Optionally, the water used in step iii) contains at least one hydrolysis catalyst. At that, the at least one hydrolysis catalyst is preferably selected from the group consisting of organic and inorganic acids, more preferably the at least one hydrolysis catalyst is acetic acid, in particular glacial acetic acid. The concentration of the at least one hydrolysis catalyst preferably lies in the range of 0.5% to 70%, more preferably of 0.7% to 10% and especially preferably of 1% to 5% per volume.

The solid surface is preferably brought into contact with water by immersion of the solid surface into water or by spraying, rolling or brushing water on the solid surface, especially preferably by immersion of the solid surface into water.

Step iii) is preferably conducted at a temperature in the range of 10 to 70° C., especially preferably at room temperature, i.e. at a temperature in the range of 15 to 30° C., preferably of 20 to 25° C.

Especially in case of immersion, the contact time in step iii) preferably lies in the range of 1 second to 10 minutes, more preferably of 5 seconds to 7 minutes, more preferably of 8 to 330 seconds, more preferably of 20 to 270 seconds, more preferably of 20 to 210 seconds, more preferably of 20 to 165 seconds, more preferably of 35 to 145 seconds, more preferably of 45 to 135 seconds and especially preferably of 55 to 125 seconds.

By choosing a contact time within these ranges, the blank corrosion resistance of the metal surface may clearly be enhanced—especially in the neutral salt spray test in accordance with ASTM B117 standard. Surprisingly, a prolonged exposure to water seems to at least partially remove the silane/silanol layer.

Furthermore, it is very easy to control the hydrolysis rate of the silane layer by means of the contact time. The longer the contact time, the higher the hydrolysis rate.

In case of immersion, the solid surface is removed from the according water bath in order to end step iii).

In case of conducting step iv) by air-blowing or wiping, the solid surface is preferably kept for at least 15 seconds, more preferably for at least 30 seconds, even more preferably for at least 45 seconds and most preferably for at least 60 seconds to allow water dropping after step iii) and before step iv)—especially if conducting step iii) by immersion. During this time the hydrolysis is continued without washing up the silane/silanol layer.

In step iv) of the method, the metal surface with the at least partially hydrolyzed silane layer is at least partially dried such that residues of water resulting from step iii) (moisture in and on the silane layer) as well as of alkanol, for example methanol or ethanol, resulting from hydrolysis are at least partially removed.

However, complete drying is not necessary, as a flexible silane/silanol layer with high viscosity and without complete drying may provide an enhanced self-healing effect (also see below) to the coating in case of being damaged. Therefore, step iv) is preferably conducted only until all drops of water are removed from the surface, which is checked visually.

Step iv) is preferably conducted by air-blowing or by wiping, especially preferably by air-blowing. At that, step iv) is preferably conducted at a temperature in the range of 15 to 35° C., especially preferably at room temperature, i.e. at a temperature in the range of 15 to 30° C., preferably of 20 to 25° C. The bigger the surface and the more complex its shape, the more time will be required to sufficiently remove water and alkanol from the surface.

According to a preferred embodiment, step v) of the method is conducted. In step v), the solid surface is heated such that the at least partially hydrolyzed and at least partially dried silane layer is cured, i.e. polymerized/cross-linked by condensation reaction between the silanol groups, such that a polysiloxane layer is formed.

Without conducting step v), i.e. when keeping the coated surface only under ambient conditions, the polysiloxane layer is formed as well but very slowly.

Step v) also helps to further remove residues of water and alkanol from the surface: Without step v), it will take a few weeks to achieve a level of drying which is acceptable in terms of good corrosion protection. In contrast to that, the coating is almost dry after one week, when step v) has been conducted.

Step v) is preferably conducted by means of an oven, preferably at a temperature in the range of 100 to 150° C., more preferably of 105 to 140° C. and especially preferably of 110 to 130° C. and for 15 to 90 minutes, more preferably for 20 to 60 minutes and especially preferably for 25 to 35 minutes.

For structural applications with certain tempered materials—especially in case of AA2XXX and AA7XXX aluminum alloys—, higher temperatures and longer heating times should be avoided in order to prevent the substrate from degradation in terms of its mechanical properties. However, for non-structural applications, e.g. for electronic housings a higher temperature and/or a longer heating time is not an issue.

After step v) the polysiloxane layer is still well flexible and may self-move to overcoat potential defects in the coating. This self-healing effect can last for several months and may be explained by the reaction between unhydrolyzed silane molecules still being present in the polysiloxane layer with atmospheric humidity that leads, by condensation reaction between the new silanol groups, to hydrolysis and formation of new cross-links. That also means that the protection performance of the coating will be increased with aging.

In step vi) of the method, the solid surface exhibiting the silane-based coating may optionally be painted by bringing the solid surface, especially in case of being a metal surface, into contact with a least one paint composition such that at least one paint layer is formed on the solid surface, which is subsequently cured by means of heat or radiation. This way, it is also possible to provide the solid surface with a paint construction consisting of at least two different paint layers as being common in the field of transportation industry. However, it is only possible to conduct step vi) when conducting step v) before.

Suitable paints are for example powder coatings. An especially suitable paint showing very good paint adhesion to and thereby very good corrosion protection for metal surfaces as for example magnesium, is Rilsan® polyamide powder coating (available from Arkema Group, France).

However, because of said blank corrosion resistance the metal surfaces may be stored and/or shipped before being painted. Therefore, according to a first preferred embodiment, the solid surface, in particular a metal surface, is painted not before 24 hours, more preferably not before 48 hours, more preferably not before 72 hours, more preferably not before one week and especially preferably not before one month after having conducted step v) of the method.

Moreover, according to a second preferred embodiment, the solid surface, in particular a metal surface, is not painted at all, as the blank corrosion resistance of the metal surface is very good. This is especially advantageous in the field of electrically conductive assembling, where unpainted metal surfaces are often used as electrical conductors, for example to provide grounding for structures.

The present invention also relates to a silane-containing composition for applying silane-based coatings to solid surfaces, in particular metal surfaces, which contains
a) at least one unhydrolyzed silane and
b) at least one corrosion inhibitor and/or at least one water-free and water-unsoluble powder,

wherein the composition does not contain water.

The inventive composition preferably does neither contain water nor organic solvents.

However, that the composition “does not contain water” or “does neither contain water nor organic solvents”, should not exclude that the composition may accidently contain minor amounts of water and/or organic solvents being impurities of components a) and/or b) and/or originating from the surrounding atmosphere. Preferably, the composition contains no water at all and more preferably no water at all and no organic solvents at all.

According to a first preferred embodiment, the inventive composition contains at least one corrosion inhibitor, more preferably benzotriazole. At that, the composition preferably is a solution, i.e. only contains dissolved substances.

According to a second preferred embodiment, the inventive composition contains at least one water-free and water-unsoluble powder, more preferably containing or even consisting of graphite, graphene, zirconium oxide, titanium oxide, silicon oxide, silicon carbide and/or aluminum oxide.

Further preferred embodiments of the inventive composition have already been set forth herein above at the description of the inventive method.

The present invention also relates to a solid surface, in particular a metal surface, with a silane-based coating, which is obtainable by the inventive method, wherein the silane-based coating exhibits an average thickness of at least 100 nanometers, preferably of at least 500 nanometers, even more preferably of at least 1 micrometer and most preferably between 1 and 5 micrometers, and which is optionally painted.

Finally, the present invention relates to the use of the inventive solid surface, in particular a metal surface, being obtainable with the inventive method in the field of transportation industry, including but not limited to air, land and marine vehicles, especially in the field of aerospace industry, including but not limited to airplanes, or in the field of electrically conductive assembling.

The following examples and comparative examples serve to illustrate the present invention without intending to limit the scope of the invention.

### EXAMPLES

Oxsilan® MG-0611, which is a mixture of unhydrolyzed bi-silanes available from Chemetall GmbH (Germany), was used in the examples.

### Stability of Specific Silanes in Water-Based Solution

Comparative Solution no. 1 was prepared in accordance with the manufacturer instruction: 50 ml of Oxsilan® MG-0611 were mixed with 50 ml of deionized water and stirred for four hours. Then 900 ml of a 1:1 mixture of Dowanol® PM and Dowanol® PnB glycol ether solvents (Dow, USA) were added to the solution of hydrolyzed silanes and mixed.

Comparative Solution no. 2 was prepared by addition of 50 ml of Oxsilan® MG-0611 to 950 ml of deionized water during mechanical stirring.

The stability of both solutions was visually checked. Comparative Solution no. 1 was still clear without any evidence of silane condensation after 6 months, whereas, Comparative Solution no. 2 became completely milky already after 10 minutes due to full condensation of the contained silanes.

### Preparation of Inventive Solution

The Inventive Solution was prepared by addition of 5 gram of Irgamet® BTZ corrosion inhibitor (BASF, Germany) to one liter of Oxsilan® MG-0611. The resulting mixture was stirred until full dissolution of the inhibitor.

### Blank Corrosion Resistance

Standard AA2024-T3 bare aluminum panels (available from Constellium company, The Netherlands) were cleaned in Ardrox® 6490, alkaline etched in Oakite® 160 and desmutted in Ardrox® 295 GD (all solutions available from Chemetall GmbH, Germany). Subsequently, the panels were immersed into the Inventive Solution for 5 minutes. The resulting silane layer was then hydrolyzed by immersion of the panels into deionized water in accordance with the following Tab. 1. Three panels were treated in every batch.

TABLE 1

| | Batch no. | | | | | | | | |
|---|---|---|---|---|---|---|---|---|---|
| | 1 | 2 | 3 | 4 | 5 | 6 | 7 | 8 | 9 |
| Contact time | 10 | 30 | 60 | 90 | 120 | 150 | 180 | 240 | 300 |
| (sec) | | | | | | | | | |

Batch no. 10 was immersed into Comparative Solution no. 1 containing pre-hydrolyzed silanes (see above) for 5 minutes. A subsequent immersion into deionized water, i.e. an additional hydrolysis, was not conducted.

After one minute for water dropping, the panels were air-blown to reduce residues of water or—in case of batch no. 10—of treatment solution and dried in an oven at 120° C. for 30 minutes.

Subsequently, the panels were cooled down to room temperature, stored for one week and then tested in a Neutral Salt Spray (NSS) test in accordance with ASTM B117 standard. The test results were evaluated in accordance with MIL-DTL-5541E standard.

Batches no. 1, 2, 6, 7, 8, 9 showed more than 5 pits after 168 hours. However, the corrosion was only in form of small isolated pits. The reference panels (batch no. 10) were significantly corroded already after 48 hours and, by far, showed the worst result in the test: 100% of the surface was corroded after 168 hours. In contrast to that, batches no. 3, 4 and 5 showed less than 5 small isolated pits after 168 hours, i.e. no or only minor corrosion.

Thus, when applying an inventive solution containing unhydrolyzed silanes with the inventive method, significantly improved blank corrosion resistance was achieved in comparison with applying a comparative solution containing pre-hydrolyzed silanes.

Moreover, there was an optimal window for the contact time of the silane layer with the deionized water achieving a maximum of protection. It has surprisingly been found that the further exposure to deionized water seems to at least partially remove the silane layer.

### Investigation of “in Place” Hydrolyzed Silane Layer

Uncoated panels and the panels of batch no. 3 exhibiting a hydrolyzed and cured silane-based coating (obtained as described above) were investigated using Infrared Reflection Absorption Spectroscopy (IRRAS). As for the panels of batch no. 3, the spectra showed clear evidence of the Si—O—Si (siloxane) compound spectrum at approximately 1060 cm⁻¹ and approximately 1130 cm⁻¹, which is not the case for the uncoated panels.

The Inventive Solution and the panels of batch no. 3 were investigated using Attenuated Total Reflection (ATR). The coated panels of batch no. 3 showed clear evidence of —OH group spectrum at approximately 3300 cm⁻¹ which is not observed for the Inventive Solution. This result proves the hydrolysis “in place” as well as the presence of active silanol molecules in the polysiloxane layer when the method of the invention is used.

### Use of Inventive Solution for Sealing of Anodic Layers

The Inventive Solution was prepared in accordance with the procedure described in the example “Preparation of Inventive Solution”. 5 panels (for each alloy) of AA2024-T3 and AA7075-T6 were anodized in a tartaric sulfuric anodizing process in accordance with an aerospace specification, rinsed and then immersed into the Inventive Solution for 5 minutes. Then, the panels were immersed into deionized water for 1 minute to hydrolyze the silane layer. After 1 minute for water dropping, the panels were air-blown to reduce residues of water and dried in an oven at 120° C. for 30 minutes. The panels were tested in the salt spray chamber in accordance with ASTM B117 standard for 1008 hours to evaluate anticorrosion performance.

After 1008 hours in the test, the AA2024-T3 panels only showed a minor amount of very small pits, whereas, the AA7075-T6 panels did not show any corrosion.

These results are significantly better than the 336 hours with a maximum of 5 isolated pits each having a diameter of not more than 0.031 inch required by the aerospace specification and/or MIL-A-8625 standard for sealed anodic layers.

### Anticorrosion Performance and Electrical Resistance Obtained with Graphene Additive

The Inventive Solution was prepared in accordance with the procedure described in the example “Preparation of Inventive Solution. Then, 25 gram of graphene powder (available from Talga) were added to 1 liter of the Solution and properly mixed, wherein the Solution changed the color from yellow to black. The stability of the such prepared Inventive Solution was checked by the naked eye after 2 weeks: The Solution remained black without any visible precipitation.

2 standard panels (for each alloy) of AA2024-T3 and AA7075-T6 were cleaned in Ardrox® 6490, alkaline etched in Oakite® 160 and desmutted in Ardrox® 295 GD (all solutions available from Chemetall GmbH, Germany). Then, the panels were immersed into the Inventive Solution containing graphene for 5 minutes. The resulting silane layer was then hydrolyzed by immersion of the panels into deionized water for 1 minute. After 1 minute for water dropping, the panels were air-blown to reduce residues of water and dried in an oven at 120° C. for 30 minutes. The panels were cooled down to room temperature, stored for 1 week and then tested in a Neutral Salt Spray (NSS) test in accordance with ASTM B117 standard for 168 hours. Both sets of panels did not show any evidence of corrosion after the test.

The test results showed, that the graphene additive improved anticorrosion protection for AA2024-T3 alloy: Without graphene, there were small isolated pits—mainly close to the panel edges—already after 120 hours. In case of AA7075-T6 alloy, the samples passed 168 hours in the test also without graphene.

Then, the same panels were tested for electrical resistance by means of the special test device MRP 29 manufactured by Schuetz GmbH, Germany. All tested samples showed an average electrical resistance of less than 1000 μΩ. Thus, the results are significantly better than required by the MIL-DTL-5541E standard for electrically conductive coatings being 10.000 μΩ maximum after 168 hours of Salt Spray test.

1. A method for applying a silane-based coating to a solid surface, characterized in that the solid surface is:
i) optionally cleaned, etched and/or desmutted,
ii) brought into contact with at least one unhydrolyzed silane such that an unhydrolyzed silane layer is formed on the solid surface,
iii) brought into contact with water such that the silane layer is at least partially hydrolyzed,
iv) at least partially dried such that residues of water and alkanol are at least partially removed from the solid surface,
v) optionally heated such that the at least partially hydrolyzed and least partially dried silane layer is cured, and
vi) in case that step v) is conducted, optionally painted.

2. The method according to claim 1, characterized in that the at least one unhydrolyzed silane is selected from the group consisting of sulfur-containing silanes.

3. The method according to claim 1, characterized in that the at least one unhydrolyzed silane is not stable in water-based solutions at all and is only stable in organic-solvent-based solutions.

4. The method according to claim 1, characterized in that the at least one unhydrolyzed silane is mixed with at least one corrosion inhibitor and then applied together with the at least one corrosion inhibitor to the solid surface.

5. The method according to claim 1, characterized in that the at least one unhydrolyzed silane is mixed with at least one water-free and water-insoluble electrically conductive powder before applying the at least one unhydrolyzed silane to the solid surface.

6. The method according to claim 1, characterized in that the at least one unhydrolyzed silane is not mixed with organic solvents.

7. The method according to claim 1, characterized in that in step iii) the solid surface is brought into contact with water by immersion of the solid surface into water.

8. The method according to claim 1, characterized in that the contact time in step iii) lies in the range of 8 to 330 seconds.

9. The method according to claim 1, characterized in that step iv) is conducted by air-blowing or by wiping.

10. The method according to claim 9, characterized in that the solid surface is kept for at least 15 seconds to allow water dropping after step iii) and before step iv).

11. The method according to claim 1, characterized in that step v) is conducted by an oven.

12. The method according to claim 1, characterized in that the solid surface is painted not before one week.

13. A silane-containing composition for applying silane-based coatings to solid surfaces, characterized in that it contains
a) at least one unhydrolyzed silane and
b) at least one corrosion inhibitor and/or at least one water-free and water-insoluble powder,
wherein the composition does not contain water.

14. A solid surface with a silane-based coating characterized in that it is obtained by the method according to claim 1, wherein the silane-based coating exhibits an average thickness of at least 100 nanometers.

15. A method of using the solid surface according to claim 14, the method comprising using the solid surface in the transportation industry or in electrically conductive assembling.

16. The method according to claim 1, wherein the solid surface is a metal surface.

17. The method according to claim 1, wherein the solid surface is an anodized or conversion-coated metal surface.

18. The method according to claim 1, characterized in that the at least one unhydrolyzed silane is selected from the group consisting of polysulfane silanes and mercapto silanes.

19. The method according to claim 1, characterized in that the at least one unhydrolyzed silane is mixed with benzotriazole, and then applied together with the benzotriazole to the solid surface.

20. The method according to claim 1, characterized in that the at least one unhydrolyzed silane is mixed with at least one water-free and water-insoluble electrically conductive powder containing graphite, graphene, zirconium oxide, titanium oxide, silicon oxide, silicon carbide and/or aluminum oxide, before applying the at least one unhydrolyzed silane to the solid surface.
